(19) United States
(12) Patent Application Publication
(10) Pub. No.: US 2009/0183132 A1
(43) Pub. Date: Jul. 16, 2009

(54) SEMICONDUCTOR-DEVICE MANUFACTURING METHOD, SEMICONDUCTOR-DEVICE MANUFACTURING PROGRAM AND SEMICONDUCTOR-DEVICE MANUFACTURING SYSTEM

(75) Inventors: Kyoko Izuha, Kanagawa (JP); Shinichirou Saeki, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/351,356

(22) Filed: Jan. 9, 2009

(30) Foreign Application Priority Data
Jan. 10, 2008 (JP) 2008-002806

(51) Int. Cl. G06F 17/50

(52) U.S. Cl. 716/10

(57) ABSTRACT

Disclosed herein is a semiconductor-device manufacturing method including the steps of: computing a capacitance, a resistance as well as capacitance and resistance variations as quantities generated as a result of changing the physical layout of a semiconductor integrated circuit in a range determined in advance; dividing the physical layout of the semiconductor integrated circuit into functional blocks and analyzing the physical layout in the functional-block units; computing signal delays for each of the functional blocks from the computed capacitance, the computed resistance as well as the computed capacitance and resistance variations and from a delay table provided for element and wire sections of each of the functional blocks; and finding signal delays in all the functional blocks composing the semiconductor integrated circuit on the basis of the signal delay computed for each of the functional blocks and the basis of a result of the analysis carried out on the physical layout.

### CROSS REFERENCES TO RELATED APPLICATIONS

The present invention contains subject matter related to Japanese Patent Application JP 2008-002806 filed in the Japan Patent Office on Jan. 10, 2008, the entire contents of which being incorporated herein by reference.

### BACKGROUND OF THE INVENTION

1. Field of the Invention

The present invention relates to a semiconductor-device manufacturing method for manufacturing a semiconductor device by making use of a manufacturing tolerance quantity found from a margin of a signal delay in a semiconductor integrated circuit serving as the semiconductor device, a semiconductor-device manufacturing program for manufacturing a semiconductor device in accordance with the semiconductor-device manufacturing method and a semiconductor-device manufacturing system for executing the semiconductor-device manufacturing program.

2. Description of the Related Art

In recent years, with semiconductor integrated circuits miniaturized, the physical layouts of the integrated circuits also become complex. Thus, variations of the line widths in the layouts contribute to the increasing of the complexity of effects on timings of signal propagations in the semiconductor integrated circuits. Matters related to variations in line width in the layouts from device to device (for example, from transistor to transistor) include problems caused by the variations in line width from device to device.

In the case of a transistor, the variations in line width from device to device (that is, from transistor to transistor) directly cause the speed of the transistor also to vary from device to device. Thus, in order to solve this problem, there has been studied a technology for modifying the line width (except the width of a critical path) of a transistor without affecting the speed of the transistor.

By the way, even though there has been developed an approach to problems caused by variations in line width from transistor to transistor, a ratio of delays caused by propagations of signals along wires in a semiconductor integrated circuit to signal delays in the entire circuit is increasing. In the future, it is thus necessary to develop an approach to problems due to the delays caused by propagations of signals along wires in a semiconductor integrated circuit.

Japanese Patent Laid-open No. Hei 9-198419 describes a proposal of a technique developed so far to serve as a technique for finding an effective wire capacitance from a layout. In accordance with the technique proposed in Japanese Patent Laid-open No. Hei 9-198419, a probability distribution of the wire length is computed and a probability distribution of the wire capacitance is found from capacitances per unit length. Then, a distribution of the capacitances of input/output terminals of a functional block is added to give a probability distribution of a delay time. From the probability distribution of a delay time, each probability of not satisfying specifications is compared with a value determined in advance in order to find the wire capacitance.

In addition, Japanese Patent Laid-open No. 2001-265826 proposes circuit simulation for generating a wiring structure considering variations (including variations of a wire of interest and wires surrounding the wire of interest) from manufacturing process to manufacturing process, computing a wire capacitance and carrying out a delay analysis with a high degree of precision by making use of the wire capacitance and proposes an apparatus for carrying out the circuit simulation.

On top of that, Japanese Patent Laid-open No. 2001-230323 proposes a technique for computing a wire capacitance by finding a final wire width and length of a layout of interest by making use of data of correlations between the wire spacing and the final wire width.

### SUMMARY OF THE INVENTION

As described above, there has been proposed a technique for estimating a circuit delay by estimating a wire capacitance based on an effective layout through the use of a statistical method and/or a simulation method. However, there has not been conceived a technology for associating a delay margin with a layout margin. Thus, from the circuit-characteristic point of view, the management range of the layout is not determined and, thus, it is difficult to improve the efficiency of a process of designing a layout while sustaining the required precision.

In order to solve the problems described above, in accordance with an embodiment of the present invention, there has been proposed a semiconductor-device manufacturing method for manufacturing a semiconductor device. The semiconductor-device manufacturing method has the steps of:

computing a capacitance, a resistance as well as capacitance and resistance variations as quantities generated as a result of changing the physical layout of a semiconductor integrated circuit in a range determined in advance;

dividing the physical layout of the semiconductor integrated circuit into functional blocks and analyzing the physical layout in aforementioned functional-block units;

computing signal delays for each of the functional blocks from the computed capacitance, the computed resistance as well as the computed capacitance and resistance variations and from a delay table provided for element and wire sections of each of the functional blocks;

finding signal delays in all the functional blocks composing the semiconductor integrated circuit on the basis of the signal delay computed for each of the functional blocks and the basis of a result of the analysis carried out on the physical layout;

computing an average value of the signal delays and an average value of the signal delays found for each type of the functional blocks; and

computing an average-value difference between each of average values each computed as an average value of the signal delays found for each type of the functional blocks and an average value of the signal delays in all the functional blocks.

In addition, the semiconductor-device manufacturing method may further include a process of finding a management value of wire widths for each of the functional blocks from relations between the average-value differences, the width of a change of the physical layout and the widths of the capacitance and resistance changes.

On top of that, the semiconductor-device manufacturing method may further include the steps of:

modifying the wire width of the physical layout on the basis of this management value; and

creating mask data by carrying out optical proximity correction and optical proximity correction authentication for the physical layout with the modified wire width.

In addition, the semiconductor-device manufacturing method is also a semiconductor-device manufacturing method for setting a management width of the optical proximity correction on the basis of the management value in order to converge the optical proximity correction to a quantity within a range of the set management width.

As described above, in accordance with the embodiment, a process is carried out to divide the physical layout of a semiconductor integrated circuit into functional blocks and variations in signal delay are defined for each of the functional blocks. Thus, for each net connecting the functional blocks, a management value of the wire width can be found from relations between the signal delays, the width of a variation of the physical layout and the capacitances as well as the resistances.

The management value cited above implies either a variation width for a case in which the optical proximity correction is carried out for a physical layout or a variation width in the design of the semiconductor integrated circuit. The range determined in advance is a variation range caused by dimension variations in a process of manufacturing the semiconductor integrated circuit. The delay table cited before includes gradients of signal delays of elements composing functional blocks and constants in signal delays of wires. The analysis of a physical layout is an analysis carried out on the types of functional blocks composing the physical layout, the number of functional blocks for each functional-block type, the types of elements composing each of the functional blocks, the number of elements for each element type, distributions of lengths of wires within each of the elements and lengths of wires between the elements and distributions of widths of wires within each of the elements and widths of wires between the elements.

In addition, the semiconductor-device manufacturing method may further include a process of creating a semiconductor integrated circuit by:

creating mask data through execution of optical proximity correction on the basis of the management width; and

then, making use of the mask data for carrying out a lithographic exposure process in a lithographic-exposure apparatus, an image development process and an etching process.

On top of that, in accordance with another embodiment of the present invention, there has been provided a semiconductor-device manufacturing program for manufacturing a semiconductor device. The semiconductor-device manufacturing program is a program to be executed by a computer as a program including the steps of:

computing a capacitance, a resistance as well as capacitance and resistance variations as quantities generated as a result of changing the physical layout of a semiconductor integrated circuit in a range determined in advance;

dividing the physical layout of the semiconductor integrated circuit into functional blocks and analyzing the physical layout in the functional-block units;

computing signal delays for each of the functional blocks from the computed capacitance, the computed resistance as well as the computed capacitance and resistance variations and from a delay table provided for element and wire sections of each of the functional blocks;

finding signal delays in all the functional blocks composing the semiconductor integrated circuit on the basis of the signal delay computed for each of the functional blocks and the basis of a result of the analysis carried out on the physical layout;

computing an average value of the signal delays and an average value of the signal delays found for each type of the functional blocks; and

computing an average-value difference between each of average values each computed as an average value of the signal delays found for each type of the functional blocks and an average value of the signal delays in all the functional blocks.

As described above, in accordance with the embodiment, a process is carried out to divide the physical layout of a semiconductor integrated circuit into functional blocks and variations in signal delay are defined for each of the functional blocks. Thus, for each net connecting the functional blocks, a management value of the wire width can be found from relations between the signal delays, the width of a variation of the physical layout and the capacitances as well as the resistances.

On top of that, in accordance with further embodiment of the present invention, there has been provided a semiconductor-device manufacturing system for manufacturing a semiconductor device. The semiconductor-device manufacturing system employs a computer for executing a program including the steps of:

computing a capacitance, a resistance as well as capacitance and resistance variations as quantities generated as a result of changing the physical layout of a semiconductor integrated circuit in a range determined in advance;

dividing the physical layout of the semiconductor integrated circuit into functional blocks and analyzing the physical layout in the functional-block units;

computing signal delays for each of the functional blocks from the computed capacitance, the computed resistance as well as the computed capacitance and resistance variations and from a delay table provided for element and wire sections of each of the functional blocks;

finding signal delays in all the functional blocks composing the semiconductor integrated circuit on the basis of the signal delay computed for each of the functional blocks and the basis of a result of the analysis carried out on the physical layout;

computing an average value of the signal delays and an average value of the signal delays found for each type of the functional blocks; and

computing an average-value difference between each of average values each computed as an average value of the signal delays found for each type of the functional blocks and an average value of the signal delays in all the functional blocks.

As described above, in accordance with the embodiment, a process is carried out to divide the physical layout of a semiconductor integrated circuit into functional blocks and variations in signal delay are defined for each of the functional blocks. Thus, for each net connecting the functional blocks, a management value of the wire width can be found from relations between the signal delays, the width of a variation of the physical layout and the capacitances as well as the resistances.

In the semiconductor-device manufacturing method, the semiconductor-device manufacturing program and the semiconductor-device manufacturing system which are provided by the embodiments of the present invention, a functional block is a basic circuit provided with a function for generating an output signal for an input signal in accordance with logic set in the circuit in advance. Examples of the functional block are an adder, an AND gate, an AND-NOR gate, an AND-OR gate, an AND-OR-NAND gate, an arithmetic processing circuit, a balanced buffer, a bus driver, a delay circuit, an EX-NOR gate, an inverter, a clock enabler, an EX-OR gate, an INV-NAND gate, an INV-NOR gate, a latch circuit, a NOR gate, an OR gate, an OR-AND gate, an OR-AND-NOR gate, an OR-NAND gate, an other circuit, a selector and an FF (Flip-Flop).

In accordance with the embodiments, from the circuit-characteristic point of view, the management width of the layout can be determined. Thus, it is possible to intensively manage a layout requiring strict management and ease a management width for locations each having a margin. As a result, it is possible to improve the efficiency of the work of designing a layout while sustaining the required precision.

### BRIEF DESCRIPTION OF THE DRAWINGS

These and other innovations and features of the present invention will become clear from the following description of the preferred embodiments given with reference to the accompanying drawings, in which:

FIGS. 1A and 1B are model diagrams each to be referred to in explanation of the stage delay;

FIGS. 2A to 2C are diagrams each showing a typical functional block;

FIG. 3 is a table having the form of a matrix showing differences each found as a difference between an entire-circuit average value and each of average values each computed as an average value of signal delays generated for each representative functional block;

FIG. 4 is an explanatory diagram showing a table of wire delays each computed for each representative functional block;

FIG. 5 is a diagram showing a typical path composed of functional blocks;

FIG. 6 is a diagram showing curves each representing the dependence relation between the width of a wire and the stage delay determined by the capacitance and resistance of the wire;

FIG. 7 shows a flowchart to be referred to in explanation of processing carried out by a first embodiment of the present invention;

FIG. 8 shows a flowchart to be referred to in explanation of processing carried out by a second embodiment of the present invention;

FIG. 9 shows a flowchart to be referred to in explanation of processing carried out by a third embodiment of the present invention; and

FIG. 10 shows a flowchart to be referred to in explanation of processing carried out to compute a delay margin.

### DETAILED DESCRIPTION OF THE PREFERRED EMBODIMENTS

Preferred embodiments of the present invention are described by referring to drawings as follows.

### Overview of Processing

The present invention presents a semiconductor-device manufacturing method capable of rapidly manufacturing a semiconductor integrated circuit serving as a manufacturing subject with electrical characteristics falling within a manufacturing-tolerance range of the electrical characteristics by finding margins of signal delays in the semiconductor integrated circuit with a high degree of accuracy as a part of a design aid of the semiconductor integrated circuit and by finding manufacturing tolerances from the margins of the signal delays.

In order to achieve the above goal of the present invention to present such a semiconductor-device manufacturing method, the semiconductor-device manufacturing method is provided with main processes such as:

(a) a process of computing a capacitance and a resistance as quantities generated as a result of changing the physical layout of a semiconductor integrated circuit serving as a subject of manufacturing in a range determined in advance;

(b) a process of dividing the physical layout of the semiconductor integrated circuit into functional blocks and analyzing the physical layout in aforementioned functional-block units;

(c) a process of computing signal delays for each of the functional blocks from the computed capacitance and the computed resistance and from a delay table provided for element and wire sections of each of the functional blocks;

(d) a process of finding an average value of signal delays in all the functional blocks composing the semiconductor integrated circuit and an average value of the signal delays found for each type of the functional blocks on the basis of the signal delay computed for each of the functional blocks and the basis of a result of the analysis carried out on the physical block; and

(e) a process of computing a delay margin which is an average-value difference between each of average values each computed as an average value of the signal delays found for each type of the functional blocks and an average value of the signal delays in all the functional blocks.

In addition, the semiconductor-device manufacturing method may further include a process of finding a management value of wire widths for each of the functional blocks from relations between the average-value differences, the width of a change of the physical layout and the widths of the capacitance and resistance changes by making use of the delay margin computed in one of the processes described above.

To put it more concretely, in the process (a) described above, when the physical layout of a semiconductor integrated circuit serving as a subject of manufacturing is changed in a range determined in advance, the so-called RC extraction process is carried out to compute a parasitic capacitance and a parasitic resistance. The aforementioned range determined in advance is a variation range caused by dimension variations in a process of manufacturing a semiconductor device. If necessary, a variation range set by the design engineer is used.

In addition, in the process (b) described above, the physical layout of a semiconductor integrated circuit is divided into functional blocks and the physical layout is analyzed in aforementioned functional-block units. A functional block is a basic circuit provided with a function for generating an output signal for an input signal in accordance with logic set in the circuit in advance. Examples of the functional block are an adder, an AND gate, an AND-NOR gate, an AND-OR gate, an AND-OR-NAND gate, an arithmetic processing circuit, a balanced buffer, a bus driver, a delay circuit, an EX-NOR gate, an inverter, a clock enabler, an EX-OR gate, an INV-NAND gate, an INV-NOR gate, a latch circuit, a NOR gate, an OR gate, an OR-AND gate, an OR-AND-NOR gate, an OR-NAND gate, an other circuit, a selector and an FF (Flip-Flop). It is to be noted that the examples listed above are merely typical examples. That is to say, basic circuits each serving as a functional block other than the typical examples may exist.

The predetermined analysis of a physical layout is an analysis carried out on the types of functional blocks composing the physical layout to determine the types of the functional blocks as well as an analysis carried out on the number of functional blocks for each functional-block type, the types of elements composing each of the functional blocks, the number of elements for each element type, distributions of lengths of wires within each of the elements and lengths of wires between the elements and distributions of widths of wires within each of the elements and widths of wires between the elements.

In addition, in the process (c) described above, a slew-load table of a product, the delays of which are to be computed, is prepared and a delay of a circuit in an already analyzed functional block is computed by making use of a simulator such as a wire arrangement tool. In this delay computation, a circuit delay and a wire delay which were computed in cell units in the past are computed in functional-block units. The delays computed in functional-block units is delays caused by elements composing a functional block and delays caused by wires.

On top of that, the process (d) described above is carried out to find an average value of signal delays in all the functional blocks composing the semiconductor integrated circuit and an average value of the signal delays found for each type of the functional blocks on the basis of the signal delay computed for each of the functional blocks and the basis of a result of the analysis carried out on the physical block.

In addition, the process (e) described above is carried out to compute a delay margin, which is an average-value difference between each of average values each computed as an average value of the signal delays found for each type of the functional blocks and an average value of the signal delays in all the functional blocks, by comparing each of average values each computed earlier as an average value of the signal delays found for each type of the functional blocks with an average value computed earlier as an average value of the signal delays in all the functional blocks.

In the processes described above, the physical layout of a semiconductor integrated circuit is divided into functional blocks and variations in signal delay are defined for each of the functional blocks. Thus, for each net connecting the functional blocks, a management value of the wire width can be found from relations between variations in signal delays, the wire width of a variation of the physical layout and the capacitances as well as the resistances.

### First Embodiment

First of all, a stage delay of an ordinary circuit is explained. A stage delay is found from delays of cells and delays of wires. A cell is an area in which a circuit determined in advance is created. In this embodiment, the configuration of a circuit created in a cell is larger than the configuration of a circuit created in a functional block.

In general, the stage delay T of a circuit is expressed by Eq. (1) as follows.

T=Rₒₙ(C_{w}+C_{g})+R_{w}(C_{w}+C_{g}) (1)

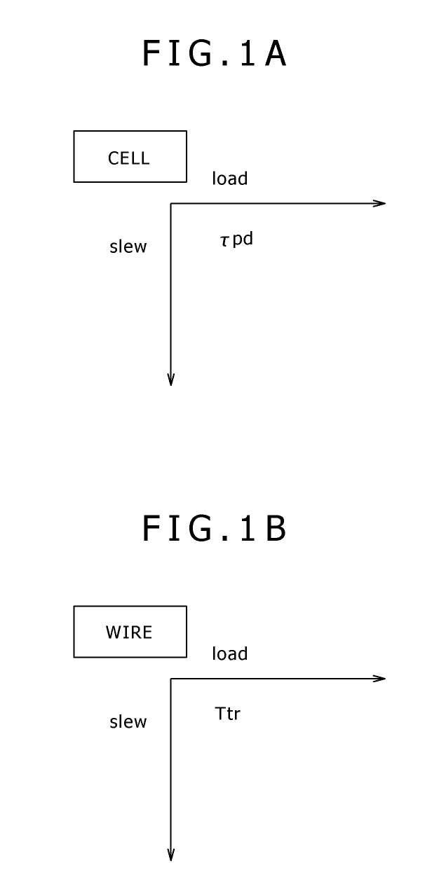

The first term of the expression on the right-hand side of Eq. (1) is the cell delay whereas the second term of the expression on the right-hand side of Eq. (1) is the wire delay. The first term Rₒₙ(C_{w}+C_{g}) corresponds to a slew and a load in a table shown in a model diagram of FIG. 1A as the delay table of the cell. On the other hand, the second term R_{w}(C_{w}+C_{g}) corresponds to a slew and a load in a table shown in a model diagram of FIG. 1B as the delay table of the wire.

FIGS. 1A and 1B are model diagrams each referred to in explanation of the stage delay. To be more specific, FIG. 1A is a model diagram referred to in explanation of the delay table of a cell whereas FIG. 1B is a model diagram referred to in explanation of the delay table of a wire. The delay table of a wire is normally constants stored inside a wire arrangement system. Thus, if the wire RC (resistances and capacitances) of a circuit is known, the wire delay can be computed. Therefore, if a circuit is determined, the stage delay can be estimated.

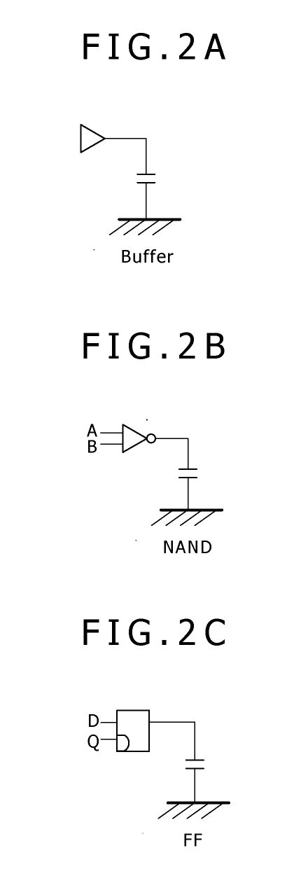

In this embodiment, a capacitance and a resistance are supplied to a delay computation system which then computes a delay. The scale of a circuit for estimating a delay applies functional block units like those shown in FIGS. 2A to 2C which are diagrams each showing a typical functional block. To be more specific, FIG. 2A is a diagram showing a typical functional block serving as a buffer whereas FIG. 2B is a diagram showing a typical functional block serving as a NAND gate. FIG. 2C is a diagram showing a typical functional block serving as a FF (Flip-Flop). However, it is to be noted that functional blocks other than these examples may be applied.

Normally, a product such as a random logic circuit in particular is complicated. It is thus difficult to estimate delays of all products by making use of only one model circuit. In this embodiment, if the functional block for solving the problems is a smallest unit, the reader is advised to pay attention to the fact that the functional block is common to all circuits. That is to say, if a functional block or a functional block including wires connecting two functional blocks is a unit, the unit can be used for any circuit. Thus, in order to obtain information on delays in functional-block units, an ordinary circuit can be expressed by combining the functional-block units of the circuit.

The smallest functional-block unit can be determined by estimating and creating a representative functional block. Let us assume that a circuit serves as a subject of manufacturing. In this case, the smallest functional-block unit can be determined by analyzing functional blocks used in the physical layout of the circuit. Let us also assume that functional blocks used in the physical layout of the circuit are analyzed. In this case, results of the analysis show the types of functional blocks composing the physical layout, the number of functional blocks for each functional-block type, the types of elements composing each of the functional blocks, the number of elements for each element type, distributions of lengths of wires within each of the elements and lengths of wires between the elements and distributions of widths of wires within each of the elements and widths of wires between the elements.

One of values each computed in functional-block units as a value related to a delay is the difference between an average value of the signal delays in all the functional blocks composing a circuit and each of average values each computed as an average value of the signal delays found for each type of the functional blocks. In this patent specification, the average value of the signal delays in all the functional blocks composing the circuit is referred to as an entire-circuit average value. That is to say, the semiconductor-device manufacturing method is implemented by execution of the steps of:

(i) finding the difference between the entire-circuit average value and each of average values each computed as an average value of the signal delays found for each type of the functional blocks;

(ii) finding a signal delay for each net (that is, for each unit connecting two functional blocks to each other by a wire) on the basis of the difference; and

(iii) finding a tolerance variation width of the wiring layout.

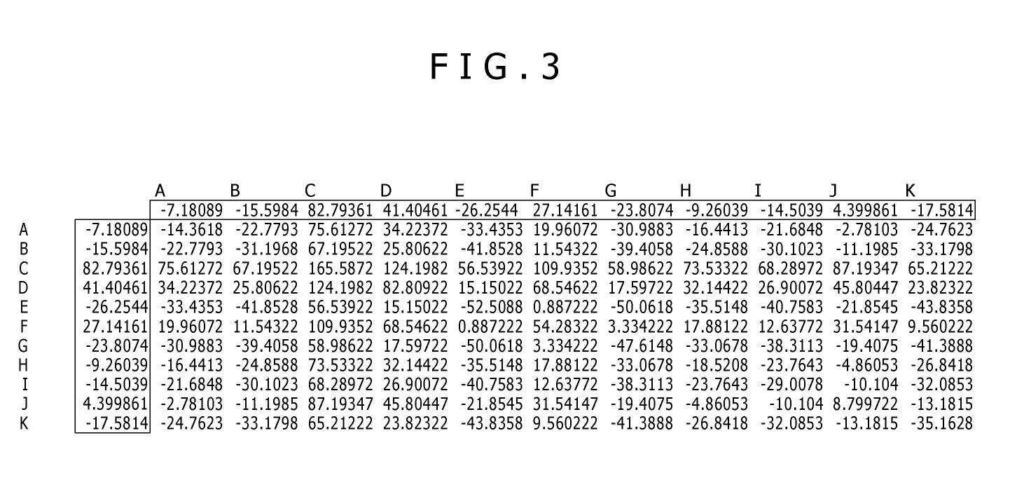

FIG. 3 is a diagram showing results of the execution of step (i) of finding the difference between the entire-circuit average value and each of average values each computed as an average value of the signal delays found for each type of the functional blocks. To put it in detail, FIG. 3 is a table having the form of a matrix showing average values each computed as an average value of the signal delays for each representative functional block and differences each found as a difference from the entire-circuit average value of delays each generated for a net connecting two functional blocks to each other by a wire. Reference notations A to K used in the table denote representative functional blocks which are an AND gate, a buffer, a delay circuit, an FF (Flip-Flop), an INV (inverter), a latch circuit, a NAND gate, a NOR gate, an OR gate, a selector, and a balanced buffer respectively. To put it in more detail, values on the left-most column and the top row are the average values each computed as an average value of the signal delays for each of functional-block types each represented by one of the representative functional blocks. On the other hand, each of the matrix elements other than the average values on the left-most column and the top row is a difference from the entire-circuit average value of delays including a delay along a wire connecting a representative functional block shown on the left-most column as a functional block associated with the difference at the matrix element to a representative functional block shown on the top row as a functional block associated with the difference at the matrix element. Each of the differences is also referred to as a delay margin. Each of the values shown in the matrix is expressed in terms of ps (pico seconds). A delay margin is used in computation of a safety margin of a signal delay.

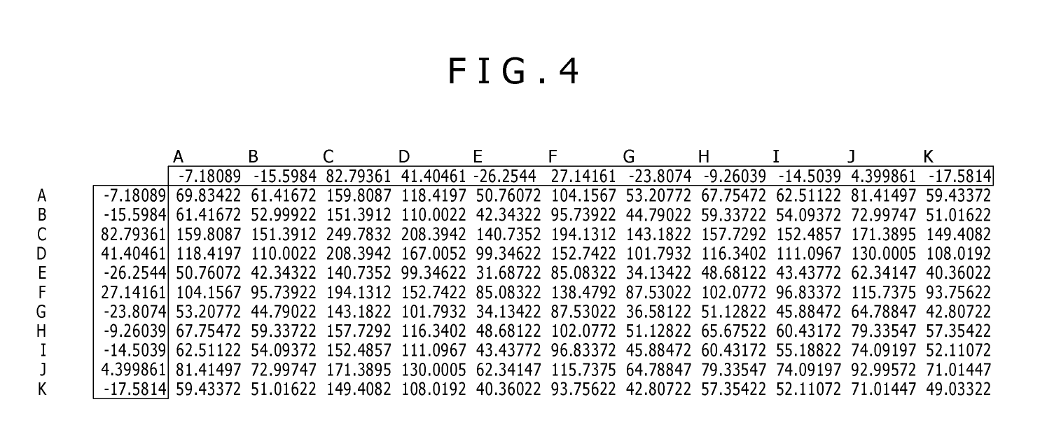

FIG. 4 is a table having the form of a matrix showing wire delays each computed on the assumption of the delay margins shown in the table of FIG. 3, the slew and load of each wire as well as a wire length in the range 10 microns to 1 mm. Each of the wire delays shown in the table of FIG. 4 is a wire delay for a wire length of 100 microns in the range 10 microns to 1 mm. Much like the table of FIG. 3, reference notations A to K used in the table of FIG. 4 denote representative functional blocks which are an AND gate, a buffer, a delay circuit, an FF (Flip-Flop), an INV (inverter), a latch circuit, a NAND gate, a NOR gate, an OR gate, a selector, and a balanced buffer respectively. In addition, the values on the left-most column and the top row are the average values each computed as an average value of the signal delays for each of functional-block types each represented by one of the representative functional blocks. On the other hand, each of the matrix elements other than the average values on the left-most column and the top row is a wire delay computed for a case in which a representative functional block shown on the left-most column as a functional block associated with the wire delay at the matrix element is connected to a representative functional block shown on the top row as a functional block associated with the wire delay at the matrix element.

Next, for a delay margin obtained in this way, a safety margin is computed. The safety margin is a quantity representing the degree to which a margin can be provided in a process.

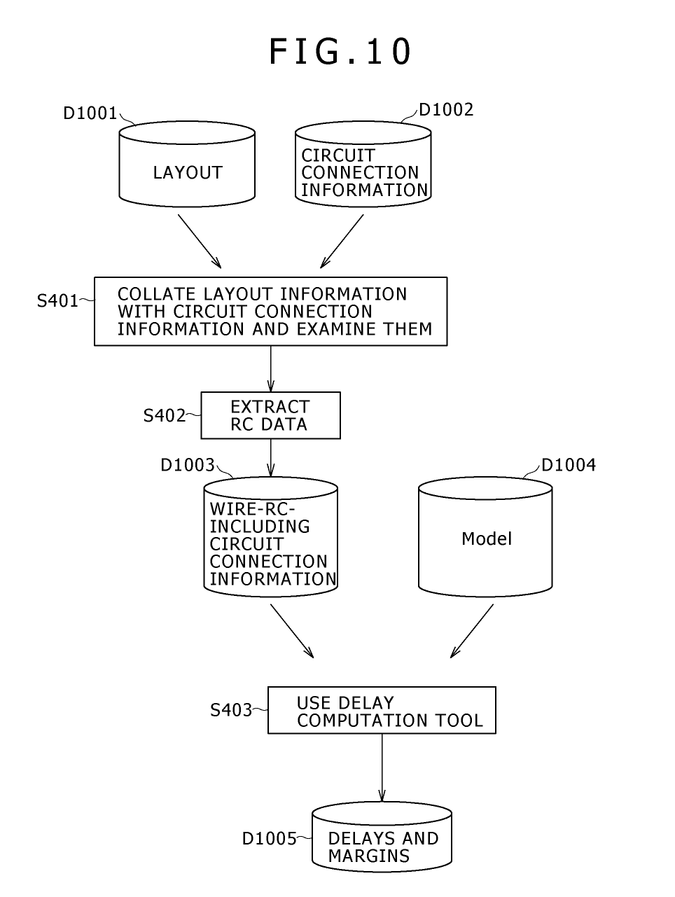

In general, a delay margin is computed by carrying out processing according to a scheme represented by a flowchart like one shown in a diagram of FIG. 10. The flowchart begins with a step S401 at which layout information D1001 and circuit connection information D1002 are supplied to a tool for collating the layout information D1001 and the circuit connection information D1002 with each other. This tool is a tool for examining and collating pieces of input information with each other. If the result of the information examination and information collation processes indicates no error, the flow of the processing goes on to a step S402 at which an RC extraction process is carried out. A wire RC (resistances and capacitances) obtained as a result of the RC extraction process is added to the circuit connection information D1002 in order to generate wire-RC-including circuit connection information D1003.

Then, at the next step S403, signal delays of a circuit being processed and delay margins of the circuit are computed from the wire-RC-including circuit connection information D1003 and cell transistor model information D1004 in order to generate delay and margin information D1005. In a process of computing a delay margin, the tool compares a signal delay of the circuit being processed with a result computed in accordance with one of relations (2) to (9) to be described later.

In this embodiment, as a technique for analyzing a signal delay, each of a setup analysis and a hold analysis is carried out in order to determine a degree to which a margin can be provided to a functional block in a process as a margin seen from the delay point of view. Eventually, the degree of the margin is computed as a management value (or a management width) of the layout.

A setup time of a data signal supplied to a data pin of a register is a time period immediately preceding the arrival edge (or the close edge) of a clock signal received by the register. During the setup time, the data signal is required to have already been stable in order for the data signal to be received by the register as a correct data signal. In addition, relation (2) given below imposes a constraint on the setup time.

CLK+period−data≧setup (2)

Relation (2) can be rewritten into relation (3) as follows:

CLK+period−data−setup≧0 (3)

In the above relations, reference notations CLK, period, data and setup denote the propagation time of the clock signal, a cycle time, a propagation time of the data signal along a data path and the setup time respectively.

On the other hand, a hold time of a data signal supplied to a data pin of a register is a time period immediately succeeding the arrival edge (or the close edge) of a clock signal received by the register. During the hold time, the data signal is required to still remain stable in order for the data signal to be received by the register as a correct data signal. In addition, relation (4) given below imposes a constraint on the hold time.

data−CLK≧hold (4)

Relation (4) can be rewritten into relation (5) as follows:

data−CLK−hold≧0 (5)

In the above relations, reference notations CLK, data and hold denote the propagation time of the clock signal, a propagation time of the data signal along a data bus and the hold time respectively.

By the way, considering that each of the propagation time (CLK) of the clock signal and the propagation time (data) of the data signal includes a margin, the setup time can be checked by verifying that the following relation holds true:

margin2(clock cell+clock net)+period>margin1(data cell+data net)+setup (6)

On the other hand, the hold time can be checked by verifying that the following relation holds true:

margin1(data cell+data net)>margin2(clock cell+clock net)+hold (7)

In the above relations, reference notation margin( ) denotes a margin expressed as a function of arguments put in the brackets ( ).

By comparing the margins each expressed by an expression in the above relations with a margin determined in advance, it is possible to examine a manufacturing safety margin in a process for the estimated margin of the circuit. That is to say, it is possible to examine the safety margin of a path in a functional block by comparing a hold margin (hold_margin) and a delay margin (delay_margin) which have been determined in advance as follows:

hold_margin/100>(data(min)−hold(max))/CLK(max)−1 (8)

delay_margin/100<-period/(CLK(min)−data(max)−setup(max))−1 (9)

In this embodiment, a signal delay of a functional block is examined from the table shown in FIG. 3. On the other hand, an RC extraction process gives a capacitance and a resistance which are used for computing a wire delay along a wire between functional blocks. Then, a stage delay is computed from the wire delay. It is to be noted that, at a point of time a product is determined, the layout of the product is analyzed and the frequencies of the lengths of wires between functional blocks are examined. Then, a wire length having the highest frequency is taken as the wire length and a wire delay for the wire length is found. If it is necessary to adjust the wire length, a shift from the wire length having the highest frequency is added to the current wire length or subtracted from the current wire length in order to give a post-adjustment wire length. In addition, in this embodiment, the safety margin is checked by referring to table values in accordance with relations (8) and (9). Thus, quantities indicated by the suffixes max and min are not distinguished from each other.

In this embodiment, the setup time and the hold time are checked in accordance with relations (2) and (4) given previously respectively as follows:

CLK+period−data≧setup (2)

data−CLK≧hold (4)

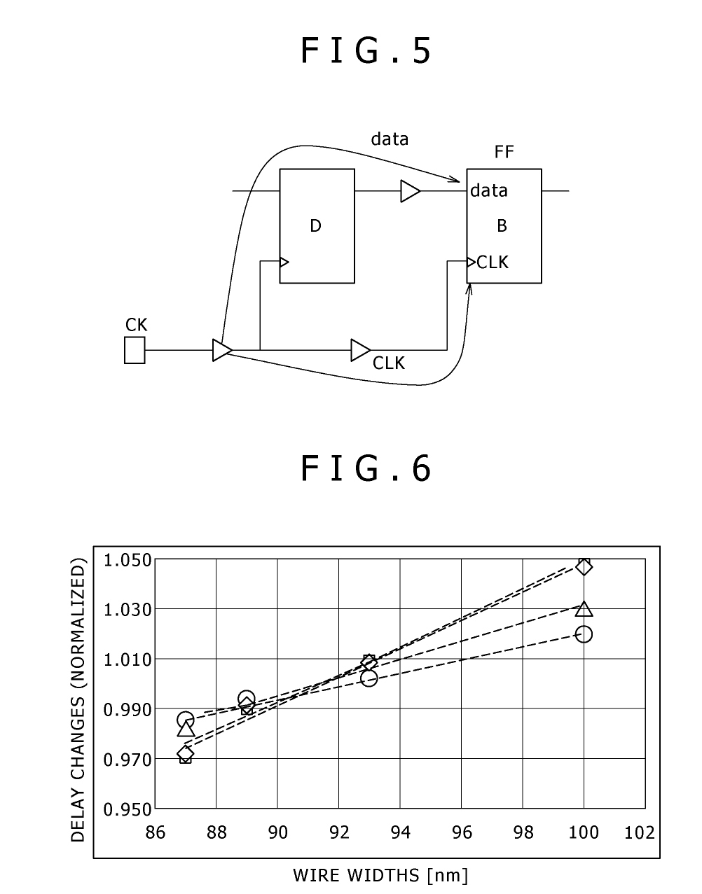

In the case of a path composed of functional blocks D and B serving as a buffer and a FF respectively as shown in a diagram of FIG. 5 for example, the data-signal propagation time data and clock-signal propagation time CLK are defined as follows:

data=wire delay+flip-flop delay+wire delay+buffer delay+wire delay (10)

CLK=wire delay+buffer delay+wire delay (11)

If values corresponding to matrix elements of D−B (FF−buffer) of the table shown in FIG. 3 are used, the following quantities have values as follows: CLK=137.5 [ps], period=500 [ps], data=27.5 [ps], setup=30 [ps], hold=0 [ps] and buffer delay=26.5 [ps]. Thus, the setup time and the hold time can be checked in accordance with relations (2) and (4).

It is to be noted that, as described above, a wire delay of a wire is computed by making use of the wire RC values including the capacitance and resistance of the wire as well as the highest-frequency wire length of a circuit composing the functional block. If connection information of the semiconductor integrated circuit is available for the processing carried out by adoption of this technique for computing a wire delay, the safety margin of a delay along a path can be found.

As a result of computation of a margin for a path composed of the functional blocks A, B, B, F and G, a safety margin of 15% is found. That is to say, relations (2) and (4) hold true. To be more specific, the value of the expression (CLK+period−data setup) of relation (2) is greater than the setup time by 15% whereas the value of the expression (data−CLK) of relation (4) is greater than the hold time by 12%. For this reason, the smaller safety margin of 12% is used as a result of the computation of the safety margin.

Next, the computed safety margin is distributed among the functional blocks A, B, B, F and G composing the path. According to the technique for distributing the safety margin among the functional blocks A, B, B, F and G, safety-margin portions are distributed among the functional blocks A, B, B, F and G in such a way that the safety-margin portions distributed among the functional blocks A, B, B, F and G are proportional to values shown in the table of FIG. 3 as values assigned to the functional blocks A, B, B, F and G. FIG. 3 is a table showing differences from the entire-circuit average value for the types A to K of the functional blocks. The ratios of the stage delay margins of the functional blocks A, B, B, F and G are found to be 1:1.1:1.1:1.3:1.5. Thus, from the safety margin of 12%, net safety-margin portions distributed among the functional blocks A, B, B, F and G are found to be 2%, 2.2%, 2.2%, 2.6% and 3% respectively. Even though the safety-margin portions has been computed from stage delay margins, since element delays do not change, the safety-margin portions can be consumed by wires connecting the elements to each other.

In the mean time, relations between wire widths and delays as well as relations between wire lengths and delays are examined separately in advance. That is to say, a wiring model structure is assumed on the basis of the device cross-sectional structure of the product and stage-delay changes, which are generated when the wire width and wire length of the wiring model structure are changed, are examined.

FIG. 6 is a diagram showing curves each representing the dependence relation between the width of a wire and the stage delay determined by the capacitance and resistance of the wire in a device used in this embodiment. The vertical axis of the diagram represents the stage delay whereas the horizontal axis represents the width of the wire in the wiring model structure. As shown in the diagram of FIG. 6, the stage delay changes linearly with the width of the wire. If the length of the wire is changed, the gradient of the curve representing the relation between the width of the wire and the stage delay also changes. That is to say, the curves in the diagram of FIG. 6 are drawn as lines having different gradients representing different wire lengths. By making use of these relations, the wire-width management value for the safety margin (or the aforementioned difference) expressed in terms of % can be found for each wire length.

In this way, the safety margin for each net connecting functional blocks to each other is computed as a quantity pertaining to a wire of the net. Even though the assigned quantity is the safety margin for each net, if a file of the post-wire-arrangement DEF (Design Exchange Format) is used, wires composing the net can be identified.

A wire composing a net is identified by adoption of this technique and, then, the management width of the wire is increased. This work is carried out for each net. Thus, the precision uniformly provided so far as the precision of the margin of the wire delay can be improved. In addition, the management width made uniform so far can be changed on the basis of the safety margin which is based on characteristics.

Then, on the basis of the management width computed by adoption of the method described above, the circuit pattern (or the mask pattern) is created and a semiconductor device is manufactured by carrying out a transcription process making use of the circuit pattern.

The method using a management width can be classified into two large categories. The method pertaining to the first category is referred to as a management-width changing method which is applied to the circuit pattern itself. The method pertaining to the second category is a method for changing a target in the OPC (Optical proximity correction). This embodiment adopts the method pertaining to the second category.

To put it concretely, the OPC and the OPC authentication are carried out on a post-wire-arrangement circuit pattern. For example, optical conditions of transcription simulation in the OPC and the OPC authentication include an exposure wavelength set at 193 nm, an NA set at 0.75 (NA=0.75), σ set at 0.85 (σ=0.85) and an orbicular zone set at ⅔. With a light exposure set at the 13.5 mJ center, the dimensions of the target of the OPC increase so that the speed of the convergence of the OPC rises. As a result, the loads borne by the OPC and the OPC authentication can be decreased. In addition, the management width of the OPC is increased, also contributing to the rising of the speed at which the OPC is converged.

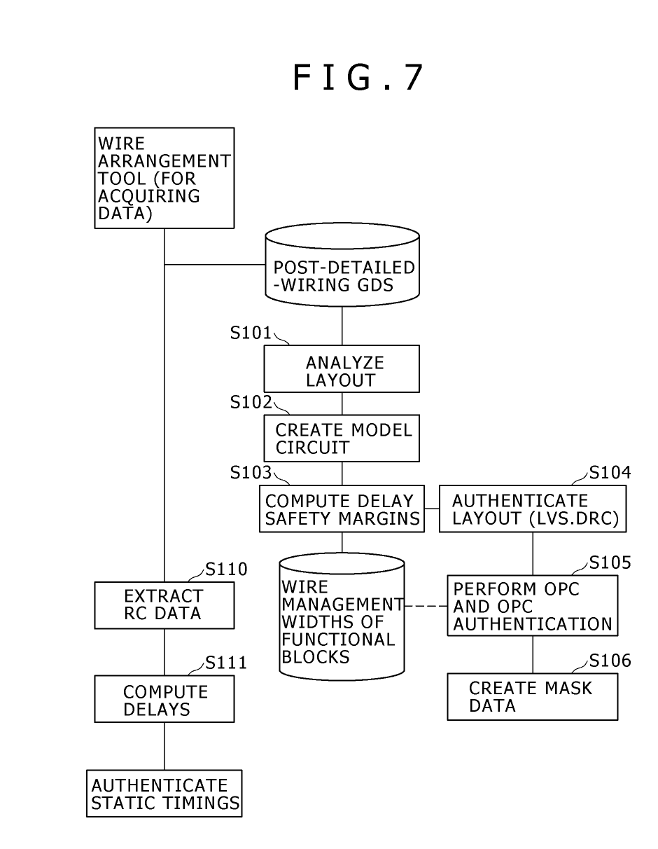

FIG. 7 shows a flowchart referred to in explanation of processing carried out by the first embodiment. The flowchart begins with a step S101 at which layout data is acquired from a wire arrangement tool and a layout represented by the layout data is analyzed by making use of the layout data. The layout data is data structured in a post-detailed-wiring GDS format. In the analysis of the layout, typically, the types of functional blocks included in the layout, the number of types, the length of each wire connecting functional blocks and the frequency of each wire length are examined.

Then, at the next step S102, a model circuit is created for each functional block by making use of results of the layout analysis. Subsequently, at the next step S103, a delay margin (the reader is suggested to refer to the table of FIG. 3) is computed for each functional block in order to find a wire management width for each functional block.

The delay margin is computed for each functional block by making use of the model circuits created earlier at the step S102, the table shown in FIG. 3 as a table of delay margins, wire RC computed on the basis of RC data extracted separately from the layout data at a step S110 and results obtained at a step Sill as results of a process of computing delays in the entire layout. Then, margins are checked in accordance with relations (2) and (4) in order to find the safety margin for all paths. Furthermore, the safety margin is distributed among nets on a proportionality basis as described above in order to find a safety margin for each net. Subsequently, a wire-width safety margin for the safety margin is found from the relations shown in the diagram of FIG. 6.

Then, at the next step S104, the layout is authenticated on the basis of the safety margins. Subsequently, at the next step S105, the target dimensions of each wire are increased and the OPC as well as the OPC authentication are carried out. In this case, the management-width changing method pertaining to the first method category cited earlier can be applied to the circuit pattern itself and the target dimensions of each wire in the OPC can be changed. Then, at the next step S106, mask data is created after the execution of the OPC and the OPC authentication.

As described above, in this embodiment, the delay margin of every wire is determined for each functional block. It is to be noted that delay margins of a device of the next generation can also be estimated as data of delay margins is accumulated for each generation. In actuality, in an estimation process carried out under a condition in which the circuit diagram is not available, a wire delay is computed by estimating the highest-frequency wire length for each generation. By carrying out a design work through the use of precise delay margins found in accordance with this embodiment, the timing-convergence processing load can be reduced.

In addition, in this embodiment, margins are checked in accordance with relations (2) and (4). However, methods for checking margins are by no means limited to this technique. That is to say, margins can also be checked in accordance with other relations according to this embodiment or in accordance with other relations set for a margin-checking purpose. In addition, methods for distributing a margin among functional blocks are by no means limited to the technique according to this embodiment.

On top of that, if a management width based on characteristic can be found, methods for finding a relation between the margin and the wire width are by no means limited to the technique according to this embodiment. In addition, in this embodiment, a wire delay is computed by making use of a wire arrangement tool. However, if the values of wire delays can be obtained, a table of wire delays can also be created in the same way as cell delays and the wire arrangement tool is thus no longer necessary. On top of that, this embodiment adopts a method for taking the wire management width into consideration in the OPC. However, the management-width changing method pertaining to the first method category cited earlier can also be adopted to change the circuit pattern itself. It is to be noted that the wire target dimensions used in the transcription simulation and a wafer transcription process can be the maximum value of the management widths or can be determined by setting a value for a type in a range of management widths.

### Second Embodiment

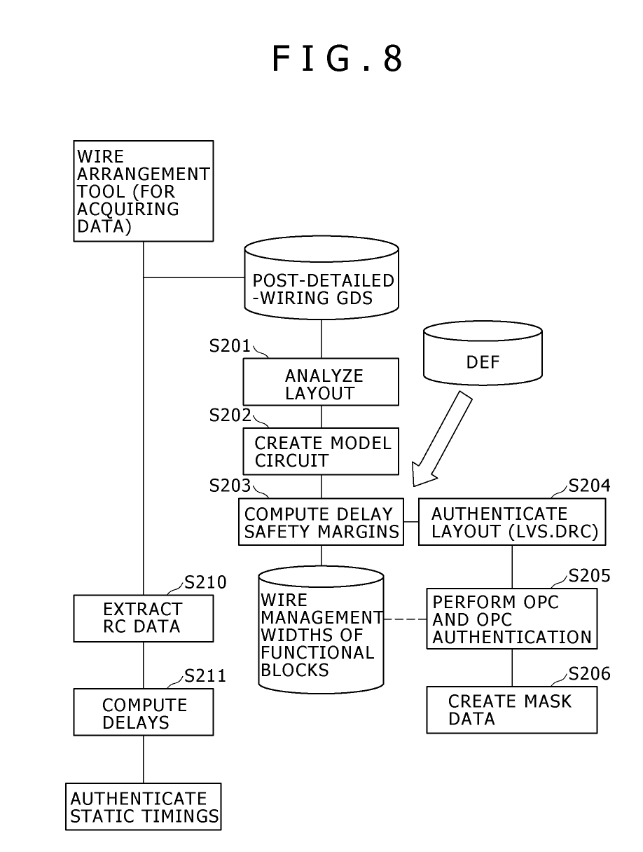

A second embodiment applies the techniques according to the first embodiment to a critical path of a circuit. FIG. 8 shows a flowchart referred to in explanation of processing carried out by the second embodiment. The flowchart begins with a step S201 at which layout data is acquired from a wire arrangement tool and a layout represented by the layout data is analyzed by making use of the layout data. The layout data is data structured in a post-detailed-wiring GDS format. In the analysis of the layout, typically, the types of functional blocks included in the layout, the number of types, the length of each wire connecting functional blocks and the frequency of each wire length are examined.

Then, at the next step S202, a model circuit is created for each functional block by making use of results of the layout analysis. Subsequently, at the next step S203, a delay margin (the reader is suggested to refer to the table of FIG. 3) is computed for each functional block in order to find a wire management width for each functional block. Then, by making use of DEF(Design Exchange Format), the layer of a layout of wires composing a net and coordinates are identified in order to determine what the management width pertains to. If a DEF file created after a detailed wiring process is used, a critical path of the circuit can be identified.

A delay margin of the critical-path portion is computed after the critical path is identified by making use of a DEF file on the basis of the model circuits created earlier at the step S202, the table shown in FIG. 3 as a table of delay margins, wire RC computed on the basis of RC data extracted separately from the layout data at a step S210 and results obtained at a step S211 as results of a process of computing delays in the entire layout.

If a file of the post-wire-arrangement DEF file is used, the location of the critical path of the circuit can be identified and, in addition, by carrying out a DEF-file layout analysis, functional blocks composing the critical path can also be identified. Then, margins are checked in accordance with relations (2) and (4) in order to find the safety margin for all paths. Furthermore, the safety margin is distributed among nets on a proportionality basis described earlier in order to find a safety margin for each net. Subsequently, a wire-width safety margin for the safety margin is found from the relations shown in the diagram of FIG. 6.

Then, at the next step S204, the layout is authenticated on the basis of the safety margins. Subsequently, at the next step S205, the target dimensions of each wire are increased and the OPC as well as the OPC authentication are carried out. In this case, the management-width changing method pertaining to the first method category cited earlier can be applied to the circuit pattern itself or the target dimensions of each wire in the OPC can be changed. Then, at the next step S206, mask data is created after the execution of the OPC and the OPC authentication.

In this embodiment, in order to improve the work efficiency, processing is carried out on only the critical-path portion. It is to be noted that, if it is difficult to change the target dimensions of the critical-path portion from the circuit-performance point of view, however, these techniques can be applied to portions other than the critical path. From the TAT (turn-around time) point of view and the quality point of view, it is nice to apply these techniques to necessary circuit portions. That is to say, if emphasis is placed on the precision, these techniques are applied to all circuits. If emphasis is placed on the TAT, on the other hand, these techniques are applied to the critical path and applied to a lithography transit pattern by making use of a filter. In addition, in the same way as the first embodiment, the management-width changing method pertaining to the first method category cited earlier can be applied to the circuit pattern itself or the target dimensions of each wire in the OPC can be changed.

### Third Embodiment

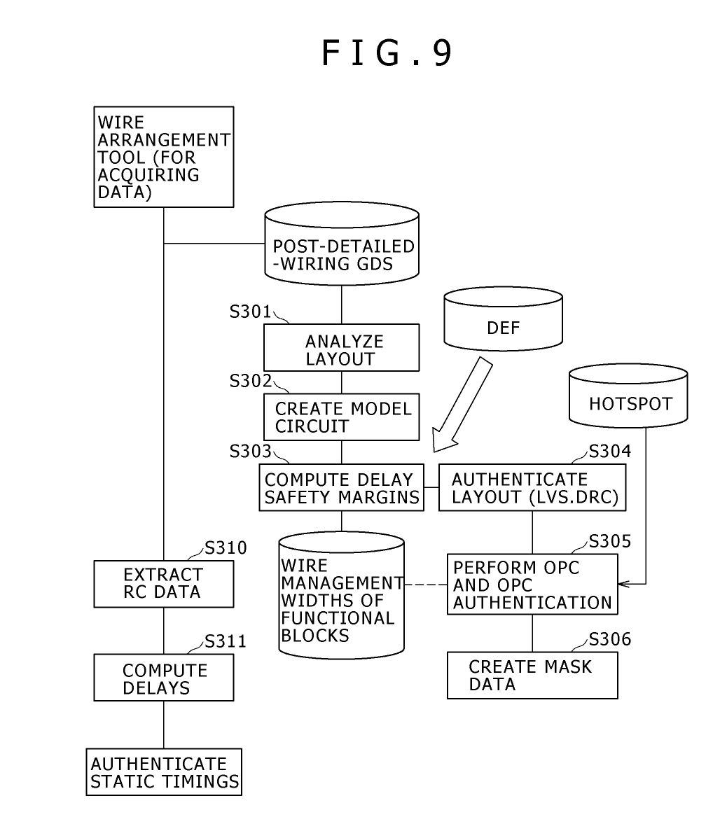

A third embodiment applies the techniques according to the first embodiment to a lithography margin transit pattern. FIG. 9 shows a flowchart referred to in explanation of processing carried out by the third embodiment. The flowchart begins with a step S301 at which layout data is acquired from a wire arrangement tool and a layout represented by the layout data is analyzed by making use of the layout data. The layout data is data structured in a post-detailed-wiring GDS format. In the analysis of the layout, typically, the types of functional blocks included in the layout, the number of types, the length of each wire connecting functional blocks and the frequency of each wire length are examined.

Then, at the next step S302, a model circuit is created for each functional block by making use of results of the layout analysis. On the other hand, at a step S304, the layout is authenticated for post-detailed-wiring GDS. Subsequently, at a step S305, the OPC and the OPC authentication are carried out and a lithography margin transit pattern is extracted. Information on the lithography margin transit pattern is recorded in a HOTSPOT file. By collating the information on the lithography margin transit pattern with information recorded in the DEF file as information on a critical path, it is possible to compute the delay safety margin of the critical-path portion which is a lithography margin transit pattern.

In order to compute these delay margins, at a step S303, a delay margin (the reader is suggested to refer to the table of FIG. 3) is computed for each functional block so as to find a wire management width for each functional block. Then, at the step S305, the maximum value of the management widths is taken as the target dimension of the OPC, and the OPC as well as the OPC authentication are again carried out in order to obtain a lithography margin. Thus, it is possible to change the mask pattern of a critical-path portion which is a lithography margin transit pattern in a range where characteristics are assured.

In addition to the process of changing the target dimension of the OPC, in this embodiment, another change is made by setting a bias of the management value on the wire width of the layout, and the OPC as well as the OPC authentication are carried out after the other change in the same way as the first and second embodiments.

In this embodiment, an intermediate value of the management width is taken as the bias width and the layout is changed. As a result, it is possible to correct a lithography margin transit pattern appearing in a critical-path portion. In this embodiment, processing is carried out on a critical-path portion which is a lithography margin transit pattern. It is to be noted that, if it is difficult to change the target dimensions of the critical-path portion from the circuit-performance point of view, however, these techniques can be applied to portions other than the critical path. From the TAT (turn-around time) point of view and the quality point of view, it is nice to apply these techniques to necessary circuit portions. That is to say, if emphasis is placed on the precision, these techniques are applied to all circuits. If emphasis is placed on the TAT, on the other hand, these techniques are applied to the critical path and applied to a lithography margin transit pattern by making use of a filter.

In addition, it should be understood by those skilled in the art that a variety of modifications, combinations, sub-combinations and alterations may occur, depending on design requirements and other factors as far as they are within the scope of the appended claims or the equivalents thereof.

### Typical Applications

The processing according to the embodiments described above can be carried by a computer for executing a program referred to as a semiconductor-device manufacturing program. The semiconductor-device manufacturing program executed by the computer includes the steps of:

(a) computing a capacitance and a resistance for a case in which the physical layout of a semiconductor integrated circuit to be manufactured is changed in a range determined in advance;

(b) dividing the physical layout of the semiconductor integrated circuit into functional block units and analyzing the physical layout in aforementioned functional-block units;

(c) computing signal delays for each of the functional blocks from the computed capacitance, the computed resistance as well as a delay table provided for element and wire sections of each of the functional blocks;

(d) computing an average value of signal delays found in all the functional blocks composing the semiconductor integrated circuit on the basis of the signal delay computed for each of the functional blocks and the basis of a result of the analysis carried out on the physical block and an average value of the signal delays found for each type of the functional blocks; and

(e) computing an average-value difference (or a delay margin) between each of average values each computed as an average value of the signal delays found for each type of the functional blocks and an average value of the signal delays in all the functional blocks.

The step (a) described above corresponds to the RC extraction step (that is, the steps S110, S210 and S310) of the flowcharts shown in FIGS. 7 to 9. The step (b) described above corresponds to the layout analysis step (that is, the steps S101, S201 and S301) of the flowcharts shown in FIGS. 7 to 9. The step (c) described above corresponds to the delay-safety-margin computation step (that is, the steps S103, S203 and S303) of the flowcharts shown in FIGS. 7 to 9. The step (d) described above corresponds to the delay computation step (that is, the steps S111, S211 and S311) and the delay-safety-margin computation step (that is, the steps S103, S203 and S303) of the flowcharts shown in FIGS. 7 to 9. The step (e) described above corresponds to the delay-safety-margin computation step (that is, the steps S103, S203 and S303) of the flowcharts shown in FIGS. 7 to 9.

A computer executes the semiconductor-device manufacturing program in order to carry out processing including these processes. In this way, it is possible to compute a process margin by finding a delay margin for each type of the functional block which is a characteristic of the embodiments.

It is to be noted that the semiconductor-device manufacturing program to be executed by a computer to carry out processing in accordance with the embodiments of the present invention is stored in advance in a predetermined recording medium such as a CD or a DVD or downloaded from a program provider by way of a network.

In addition, the semiconductor-device manufacturing program can also be executed by a computer system having a configuration advantageous for the processing to be carried out in accordance with the embodiments of the present invention. The computer system serves as a semiconductor-device manufacturing system which has hardware proper for execution of a plurality of steps described before as the steps of the semiconductor-device manufacturing program according to one of the embodiments of the present invention. Typically, the hardware has a configuration including a CPU for executing the steps at a high speed, a memory having a storage capacity large enough for execution of the steps, a storage section configured to serve as a section used for storing various kinds of data as well as other sections such as a display section and an input/output interface.

The semiconductor-device manufacturing system includes the semiconductor-device manufacturing program which has been embedded in advance therein to serve as a program according to one of the embodiments of the present invention. As an alternative, the semiconductor-device manufacturing program is a program downloaded from a program provider by way of a network and installed in the semiconductor-device manufacturing system. As another alternative, the semiconductor-device manufacturing program is a program installed in the semiconductor-device manufacturing system from a recording medium. The semiconductor-device manufacturing program is then executed by the semiconductor-device manufacturing system in order to carry out the processing which is peculiar to the semiconductor-device manufacturing system.

### EFFECTS OF THE INVENTION

In the past, in many cases, the circuit portion having an effect on a circuit time delay occupied only no more than several tens of percents of a semiconductor integrated circuit. From the delay point of view and the lithography point of view, however, the margin was provided uniformly. This is because, in the past, a wire-width variation of a layout and a wire delay were not associated with each other. In accordance with the embodiments described above, on the other hand, a margin provided so far uniformly for all portions from a delay-margin point of view can be set for each combination of functional blocks on the basis of the delays of the functional blocks. Thus, the precision of the margin can be improved. In addition, delay margins of a device of the next generation can also be estimated with a high degree of precision on the basis of delay margins of each functional block of a device of the present generation.

What is claimed is:

1. A semiconductor-device manufacturing method for manufacturing a semiconductor device, said semiconductor-device manufacturing method comprising the steps of:
computing a capacitance, a resistance as well as capacitance and resistance variations as quantities generated as a result of changing the physical layout of a semiconductor integrated circuit in a range determined in advance;
dividing said physical layout of said semiconductor integrated circuit into functional blocks and analyzing said physical layout in said functional-block units;
computing signal delays for each of said functional blocks from said computed capacitance, said computed resistance as well as said computed capacitance and resistance variations and from a delay table provided for element and wire sections of each of said functional blocks; and
finding signal delays in all said functional blocks composing said semiconductor integrated circuit on the basis of said signal delay computed for each of said functional blocks and the basis of a result of said analysis carried out on said physical layout.

2. The semiconductor-device manufacturing method according to claim 1, said semiconductor-device manufacturing method further comprising the steps of:
computing an average value of said signal delays and an average value of said signal delays found for each type of said functional blocks; and
computing an average-value difference between each of average values each computed as an average value of said signal delays found for each type of said functional blocks and an average value of said signal delays in all said functional blocks.

3. The semiconductor-device manufacturing method according to claim 1, said semiconductor-device manufacturing method further comprising the step of finding a management value of wire widths for each of said functional blocks from relations between said average-value differences, the width of a change of said physical layout and the widths of said capacitance and resistance changes.

4. The semiconductor-device manufacturing method according to claim 2, said semiconductor-device manufacturing method further comprising the steps of:
modifying the wire width of said physical layout on the basis of said management value; and
creating mask data by carrying out optical proximity correction and optical proximity correction authentication for said physical layout with said modified wire width.

5. The semiconductor-device manufacturing method according to claim 3 whereby a management width of said optical proximity correction is set on the basis of said management value in order to converge said optical proximity correction to a quantity within a range of said set management width.

6. The semiconductor-device manufacturing method according to claim 2 wherein said management value is either a variation width for a case in which said optical proximity correction is carried out for said physical layout or a variation width in the design of said semiconductor integrated circuit.

7. The semiconductor-device manufacturing method according to claim 1 wherein said range determined in advance is a variation range caused by dimension variations in a process of manufacturing said semiconductor integrated circuit.

8. The semiconductor-device manufacturing method according to claim 1 wherein said delay table includes gradients of signal delays of elements composing said functional blocks and constants in signal delays of wires.

9. The semiconductor-device manufacturing method according to claim 1 wherein said analysis of said physical layout is an analysis carried out on the types of said functional blocks composing said physical layout, the number of said functional-blocks for each functional-block type, the types of elements composing each of said functional blocks, the number of said elements for each element type, distributions of lengths of wires within each of said elements and lengths of wires between said elements and distributions of widths of wires within each of said elements and widths of wires between said elements.

10. The semiconductor-device manufacturing method according to claim 2, said semiconductor-device manufacturing method further including a process of creating said semiconductor integrated circuit by:
creating mask data through execution of optical proximity correction on the basis of said management width; and
making use of said mask data for carrying out a lithographic exposure process in a lithographic-exposure apparatus, an image development process and an etching process.

11. A semiconductor-device manufacturing program for manufacturing a semiconductor device, said semiconductor-device manufacturing program to be executed by a computer as a program including the steps of:
computing a capacitance, a resistance as well as capacitance and resistance variations as quantities generated as a result of changing the physical layout of a semiconductor integrated circuit in a range determined in advance;
dividing said physical layout of said semiconductor integrated circuit into functional blocks and analyzing said physical layout in said functional-block units;
computing signal delays for each of said functional blocks from said computed capacitance, said computed resistance as well as said computed capacitance and resistance variations and from a delay table provided for element and wire sections of each of said functional blocks;
finding signal delays in all said functional blocks composing said semiconductor integrated circuit on the basis of said signal delay computed for each of said functional blocks and the basis of a result of said analysis carried out on said physical layout;
computing an average value of said signal delays and an average value of said signal delays found for each type of said functional blocks; and
computing an average-value difference between each of average values each computed as an average value of said signal delays found for each type of said functional blocks and an average value of said signal delays in all said functional blocks.

12. A semiconductor-device manufacturing system for manufacturing a semiconductor device, said semiconductor-device manufacturing system comprising a computer for executing a program including the steps of:
computing a capacitance, a resistance as well as capacitance and resistance variations as quantities generated as a result of changing the physical layout of a semiconductor integrated circuit in a range determined in advance;
dividing said physical layout of said semiconductor integrated circuit into functional blocks and analyzing said physical layout in said functional-block units;
computing signal delays for each of said functional blocks from said computed capacitance, said computed resistance as well as said computed capacitance and resistance variations and from a delay table provided for element and wire sections of each of said functional blocks;
finding signal delays in all said functional blocks composing said semiconductor integrated circuit on the basis of said signal delay computed for each of said functional blocks and the basis of a result of said analysis carried out on said physical layout;
computing an average value of said signal delays and an average value of said signal delays found for each type of said functional blocks; and
computing an average-value difference between each of average values each computed as an average value of said signal delays found for each type of said functional blocks and an average value of said signal delays in all said functional blocks.
